(19) United States
(12) Patent Application Publication
(10) Pub. No.: US 2006/0014576 A1
(43) Pub. Date: Jan. 19, 2006

(54) Disposable cellular cover

(76) Inventor: Joe Lamont Reynolds, McDonough, GA (US)

Correspondence Address: Joe Lamont Reynolds, 489 North Green Circle, McDonough, GA, 30252, US

(21) Appl. No.: 10/894,464

(22) Filed: Jul. 19, 2004

(51) Int. Cl. H04M 1/00

(52) U.S. Cl. 455/575.8; 455/90.3; 455/575.1

(57) ABSTRACT

A disposable cover includes a flexible tubular chambered body (12) with a smooth surface having an opened end (16) at the base (14) and an antenna enclosure (10) at the closed end (18). The chambered body (12) is formed of latex or rubber material having a constant diameter from opened end (16) to its closed end (18). The tubular body (12) includes an antenna enclosure (10) wherein the small chamber extends fixed thereof the closed end (18) of the body (12) thereof one side.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention is a transparent latex or rubber material that would cover and protect a cellular phone, available in clear or light colors.

### BACKGROUND OF THE INVENTION

Other covers may be used just for carrying cell phones or protection from just scuffing. They may also allow cellular phones to be ruined when subjected to water, sand, lotions, grease, dirt, snow, and other foreign materials. Other covers may prevent use when working with greasy equipment or playing at a pool or beach.

### BACKGROUND OF THE INVENTION—OBJECTS AND ADVANTAGES

Besides the objects and advantages of holsters and carrying cases, there are many obects and advantages of the present invention described in the above patent.
(a) to provide a cover which will not be slippery when handled with wet or greasy fingers;
(b) to provide a cover which cannot be altered;
(c) to provide a cover whose production allows for a convenient and rapid production;
(d) to provide a cover which can be produced in a variety of colors;
(e) to provide a cover that can be made to fit any size or shape of phone;
(f) to provide a cover that could be sold in small convenient packages;
(g) to provide a cover that is disposable after each use;
(h) to provide a cover that would be water-tight;
(i) to provide a cover that would snugly fit your phone as well as your hand;
(j) to provide a cover that would be very affordable;

Further objects and advantages are to provide use at a beach while using lotion and playing in the water or at work while having dirty or greasy hands. It could also protect a phone from snow and icy weather.

### SUMMARY

In essence, the present invention compliments standard carrying cases, allowing a user to return a phone to a carrying case and still ensures a phone from the damages caused from water, sand, lotion, grease, dirt, and other foreign materials. The long tubular body can be easily rolled on in seconds and removed just the same. The tubular body is opened at one end and closed at the other. Its body is made of a thin latex material that will conform to fit any cellular phone snugly. After a latex cover has been pulled down completely, it should be tied with a knot. A disposable latex cover will allow a user to have a cover that can give a phone protection in conditions normally harmful to cellular phones, yet allow complete control of the functions.

### DRAWINGS—FIGURES

FIG. 1 is a perspective view of a disposable cellular cover at full length from the opened end thereof.

FIG. 2 is a perspective view of a disposable cellular cover at full length from the closed end thereof.

FIG. 3 is a perspective view of a disposable cellular cover in a rolled up position.

### DRAWINGS—REFERENCE NUMERALS

10 Antenna Enclosure
12 Body
14 Base
16 Opened End
18 Closed End

### DETAILED DESCRIPTION—FIGS—PREFERRED EMBODIMENT

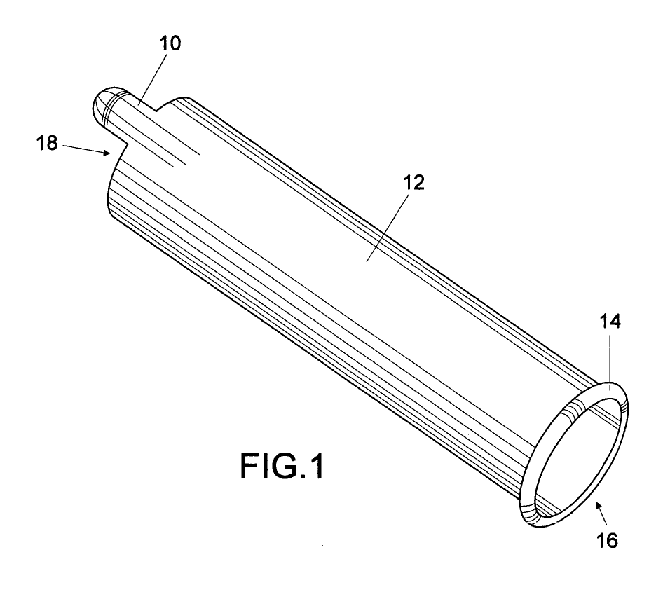

A preferred embodiment of a disposable cover in the present invention is illustrated in FIG. 1. The flexible tubular body 12 is a thin layer of latex material about 0.4 mm thick, having an opened end 16 and a closed end 18 wherein an antenna enclosure 10 is fixed thereof at the closed end 18. A disposable cover is a smooth texture that would make handling easier while installing a phone and adjusting for proper fitting. The body 12 would have a length of 130 mm which would be long enough to pull downward and tie into a knot. The tubular body 12 would have a generally constant diameter from its opened end 16 to its closed end 18, defining a longitudinally extending chamber.

The second embodiment of the invention is illustrated in FIG. 2 and is the same descriptions as FIG. 1 but shown from a different view. This will give another perspective of the antenna enclosure 10 wherein the small chamber extends thereof the closed end 18.

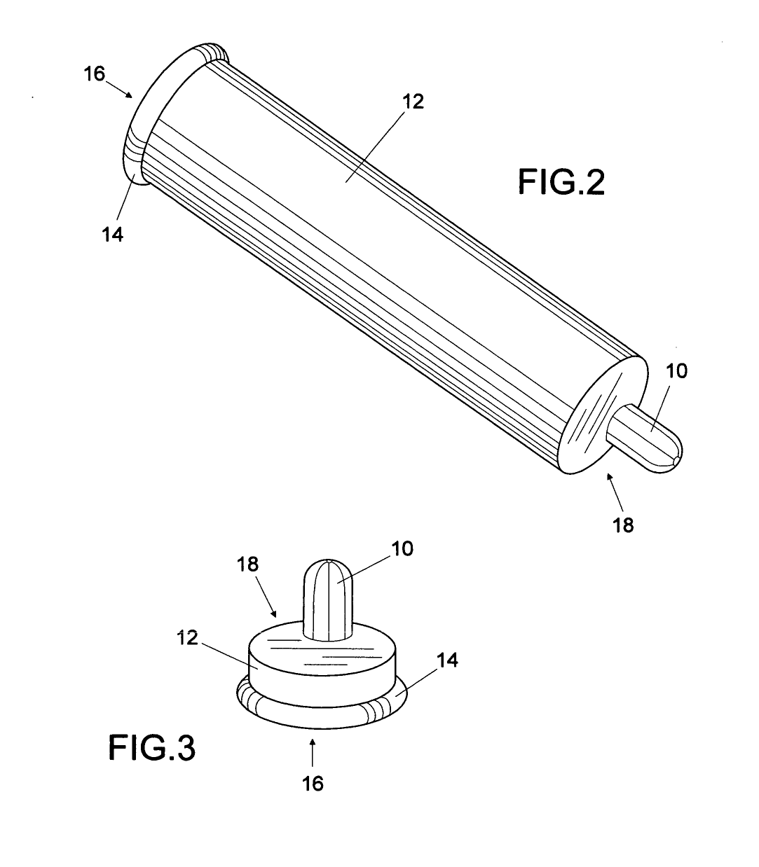

FIG. 3 illustrates a third embodiment of the invention wherein the body 12 is rolled up from the base 14 wherein the closed end 18 projects about 5 mm thereof.

Operation:

A manner of using a disposable cover to seal and protect a cellular phone is to stretch the opened end 16 thereof the base 14 over the top of a cellular phone while adjusting the antenna into the antenna enclosure 10. Then the cover is rolled or pulled downward from the opened end 16 until the tubular chamber overruns the bottom end of the cellular phone. After pulling a latex or rubber cover that is extremely flexible and elastic over the body 12, it would be twisted at the opened end 16 thereof base 14 and tied into a knot. To remove a latex or rubber chamber that has sealed and protected a cellular phone from debris or fluids, punch a hole in wall of the body 12 and tear away from cellular phone.

### CONCLUSION, RAMIFICATIONS, AND SCOPE

Accordingly, a reader will see that a disposable latex cover of this invention can be used to seal a cellular phone from damaging elements, such as water, grease, sand, dirt, oils, or snow and can be removed just as easily. A disposable cover can be packaged for convenience, handling, and storage. Once a cellular phone has been installed into the cover, it can be used without impairing the ability of using a cellular phone, using the keypad, or talking and listening on a phone. Furthermore, a disposable latex cover has an additional advantage in that:
(A) It permits the production of a cover in a variety of light and neon transparent colors.
(B) It provides a superior surface that would not be slippery while having wet or greasy hands.
(C) It provides a latex chamber that would conform to fit any shape or size of cellular phone.

Although the descriptions above contains many specificities, these should not be construed as limiting the scope of the invention, but merely as providing illustrations of some of the presently preferred embodiments of this invention. For example, a cover could have different textures or colors, and could vary in shape or size.

I claim:

1. A flexible disposable cover comprising a flexible tubular body having an open end and closed end with an outer and inner surface. Said tubular chambered body is formed of latex or rubber material, having a constant diameter from its opened end to its closed end wherein said tubular antenna enclosure chamber that projects extending along one side from the closed end thereof.

2. A flexible disposable cover according to claim 1 wherein said body of material is made of latex or rubber material with a length of about 130 mm.

3. A flexible disposable cover according to claim 2 wherein said body is a flexible longitudinal chamber with a diameter of about 30 mm.

4. A flexible disposable cover according to claim 3 wherein said body has an opened end thereof said base.

5. A flexible disposable cover according to claim 4 wherein said base with a diameter of about 3 mm is the rim of the opened end of the chamber.

6. A flexible disposable cover according to claim 5 wherein said closed end has an antenna enclosure set to one side on said body extending thereof said closed end.

7. A flexible disposable cover according to claim 6 wherein said tubular antenna enclosure extends about 30 mm with a diameter of about 9 mm.
